(19) United States
(12) Patent Application Publication
(10) Pub. No.: US 2015/0142539 A1
(43) Pub. Date: May 21, 2015

(54) METHODS AND SYSTEMS FOR MANAGING A CUSTOMER LOYALTY PROGRAM

(71) Applicant: Shoutz, Inc., Austin, TX (US)

(72) Inventor: James G. Mueller, Austin, TX (US)

(73) Assignee: Shoutz, Inc., Austin, TX (US)

(21) Appl. No.: 14/542,948

(22) Filed: Nov. 17, 2014

Related U.S. Application Data
(60) Provisional application No. 61/905,233, filed on Nov. 17, 2013.
(60) Provisional application No. 61/905,232, filed on Nov. 17, 2013.

(51) Int. Cl. G06Q 30/02; G06Q 50/00

(52) U.S. Cl. CPC G06Q 30/0212; G06Q 30/0226; G06Q 50/01
USPC 705/14.14

(57) ABSTRACT

Method and system is disclosed for providing rewards to a loyalty program customer. The method includes receiving operating parameters for a selected computer-implemented game, receiving lottery-based information, determining odds based upon the received operating parameters and the received information, executing the selected computer-implemented game based upon the determined odds and the received operating parameters, determining a reward for the loyalty program customer based at least in part on the executing of the selected computer-implemented game, providing an offer of the reward to the loyalty program customer, and updating an account associated with the loyalty program customer based upon the providing. The method can further include changing the offer based upon distribution of information associated with the game to contacts of a user's virtual social network.

### CROSS REFERENCE TO RELATED APPLICATIONS

This application claims the benefit of U.S. Provisional Application No. 61/905,233 filed on Nov. 17, 2013 and U.S. Provisional Application No. 61/905,232 filed on Nov. 17, 2013, both hereby incorporated herein by reference.

### TECHNICAL FIELD

This disclosure relates to loyalty programs, and more particularly to methods and systems for managing customer loyalty programs and providing rewards to a loyalty program customer.

### BACKGROUND

The statements in this section merely provide background information related to the present disclosure and may not constitute prior art.

Loyalty and reward programs are important marketing tools for retailers and ecommerce merchants. Active loyalty program members shop at retailers and online merchants with greater frequency than non-loyalty program members, thereby increasing revenue and decreasing sales volatility. Loyalty programs allow retailers and online merchants to reward preferred customers with special offers and other benefits, creating greater brand awareness and brand loyalty.

Many loyalty programs offer drawings or contests to their members. In known programs, members are able to earn entries or points based on their purchases of the retailer's products and apply credits or points for their purchases towards entries in the drawings. Loyalty programs are known to use different contest strategies and prizes to keep their members engaged. One strategic approach includes giving away a high number of small prizes, for instance $20 gift cards for use at the retailer. Because so many prizes are given out, loyalty participants have a much higher chance of winning a prize and feeling rewarded for their loyalty to the brand.

Loyalty programs also have costs associated with them. The cost of the giveaways cannot be higher than the value the retailer receives through a satisfied repeat customer. So loyalty programs are typically executed after careful calculations involving the amount of prizes they will give away. A number of metrics are used to shape execution of the awards. Typically a prize budget is set and then the loyalty program operator uses the projected traffic to the loyalty program website to calculate the odds of winning that will result in the targeted prize amount being distributed. If the odds are set too high, fewer loyalty members will win prizes and the loyalty program could be viewed as misleading participants. If the odds are set too low, the number and costs of the prizes given away could be higher than budgeted, with a negative impact on the company's profitability. For this reason, loyalty program operators are very careful in how they set their odds for the loyalty program contests.

Loyalty programs for lotteries face unique challenges. For traditional retailers, the traffic to their online stores and loyalty websites is both steady and predictable. Retailers are able to make adjustments for known seasonality patterns and based on planned marketing campaigns. However, lotteries, sweepstakes and other games of chance lack this predictability. The size of the lottery winning pool depends on whether or not somebody won the previous drawing. If so, the lottery winning pool can be quite low. However if there are no winners for weeks or even months, the size of the lottery winning pool can become extremely large; as an example, the Powerball™ prize pool reached over $500 million in 2013. In the context of this variability, lottery rewards programs would benefit from a system that was able to generate odds based upon lottery-events including projected ticket sales, estimated jackpots, and/or estimated website traffic.

Further, virtual social networks have changed how people interact with their friends and communities. The virtual social networks allow people to instantaneously share their thoughts, emotions and activities, through words, pictures and video. This ability to communicate quickly and with impact is creating vast interwoven networks of people with common friends and common interests.

Retailers have increasingly turned to social network systems as an advertising tool and a means of promoting their loyalty and rewards programs. For retailers, the social network systems represent both opportunities and challenges. A recommendation shared on a social network system to a user's contacts is a powerful endorsement that gets peoples' attention and effects positive influence more than paid advertising. However, many people are protective of their social networks and do not want to be perceived as profiting from their friends. This hesitation impedes retailers' efforts to promote social sharing as a means of promoting their brand and loyalty programs. Therefore, it would be advantageous to encourage sharing of commercial information to a user's social network contacts.

### SUMMARY

A method is disclosed for providing rewards to a loyalty program customer. The method includes receiving operating parameters for a selected computer-implemented game, receiving lottery-based information, determining odds based upon the received operating parameters and the received information, executing the selected computer-implemented game based upon the determined odds and the received operating parameters, determining a reward for the loyalty program customer based at least in part on the executing of the selected computer-implemented game, providing an offer of the reward to the loyalty program customer, and updating an account associated with the loyalty program customer based upon the providing. The method can further include changing the offer based upon distribution of information associated with the game to contacts of a user's virtual social network.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows a loyalty program management system, in accordance with the present disclosure;

FIG. 2 shows an exemplary embodiment of a server of FIG. 1 having an odds calculation module and a drawing operations module, in accordance with the present disclosure; and

FIG. 3 shows a process for awarding prizes corresponding to winning games and/or sweepstakes events, in accordance with the present disclosure.

### DETAILED DESCRIPTION

Described herein is a loyalty program management system for extending loyalty programs to end-consumers or clients. The present invention allows a retailer to offer an electronic loyalty program to the end-consumer via a unique computerized distribution and clearing house system. For example, in an exemplary embodiment, a consumer registers for participation in the loyalty program and subsequently purchases a product from a retailer. When certain predetermined criteria are achieved and/or certain events executed, the consumer is rewarded and issued a reward which may be redeemed according to the terms of the loyalty program. The retailer then fulfills the coupon value or redeems the reward at the consumer's request.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

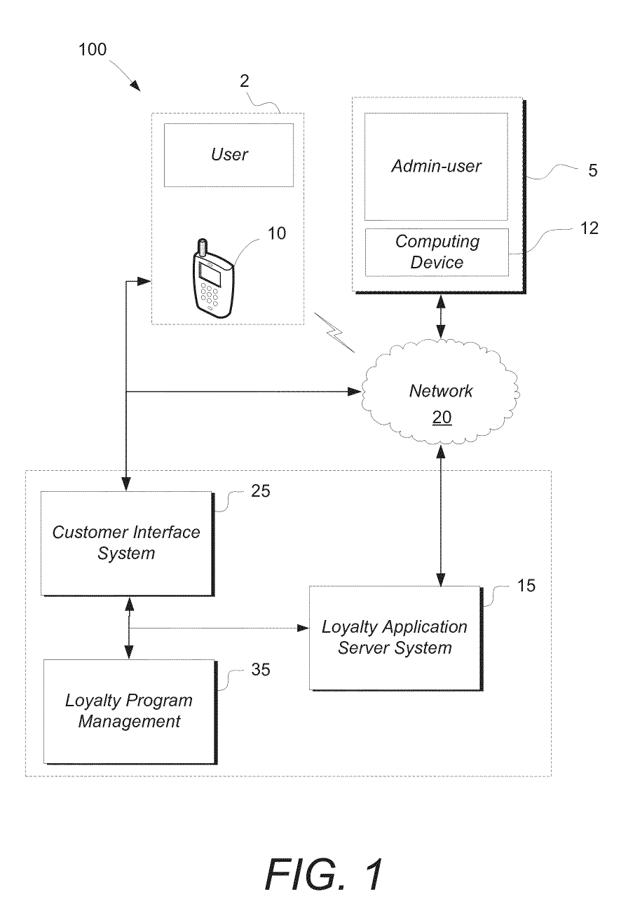

An exemplary loyalty program management system of the present invention is depicted in FIG. 1. Although, the present invention may be described herein in terms of functional block components, flow charts, screen shots, optional selections and various processing steps. It should be appreciated that such functional blocks may be realized by any number of hardware and/or software components configured to perform the specified functions. For example, the present invention may employ various integrated circuit components, (e.g., memory elements, processing elements, logic elements, look-up tables, and the like), which may carry out a variety of functions under the control of one or more microprocessors or other control devices. Similarly, the software elements of the present invention may be implemented with any programming or scripting language with the various algorithms being implemented with any combination of data structures, objects, processes, routines or other programming elements. Further, it should be noted that the present invention may employ any number of conventional techniques for data transmission, signaling, data processing, network control, and the like.

Similarly, it should be appreciated that the particular implementations shown and described herein are illustrative of the invention and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a loyalty application.

Turning now to exemplary components of the present invention, a loyalty management system 100, as depicted in FIG. 1, administers, manages, and executes functionality related to a loyalty program for a consumer. The system 100 involves one or more users 2 (e.g., consumers), any admin-user 5 communicating loyalty program data to and from the loyalty system 100 to effect the loyalty program administration, management, registration and redemption aspects of the present invention.

The admin-user 5, as contemplated by this invention, is any entity (e.g., ecommerce merchant, manufacturer, service provider, wholesaler, distributor, point-of-sale store, virtual storefront, e.g., website, etc.) providing any type of electronic or computer-facilitated loyalty program. Exemplary loyalty programs may be designed, for example, to reward customers based on a purchase, frequency of purchase, and/or monetary value of purchase. An exemplary program may provide that (1) if a user purchases 10 lottery tickets, the user gets one free (i.e., frequency); (2) if the user spends $100 on lottery tickets, the user gets a 5 percent discount (i.e., pecuniary value); (3) if the user buys lottery tickets within 10 days, the user gets a 10 percent discount (temporal-based redemption). In one embodiment, the loyalty program may also be a progressive loyalty system, where the reward is promoted each time a new milestone is reached. For example, the user may decline the five percent reward after spending $10 waiting instead until $100 is spent to recognize a 25 percent discount reward.

A user 2 is depicted in FIG. 1 as a mobile device, such illustration is provided as a convenience upon a careful reading of the teachings herein it will be apparent that any number of computing devices may be configured to perform the functions described herein. A user 2, may be any entity, person, utilizing any one of a variety of electronic loyalty programs. The user 2 includes transaction, loyalty, charge and credit cardholders, consumers, customers, purchasers, and/or the like. The user 2 communicates with and within the system 100 and admin-user 5 via a communication device and/or computing device, which is suitably configured to access a computerized network 20. The user system 10 is such a communication device and may include any computerized system such as a personal computer, tablet or mobile device. In an exemplary embodiment, and as shown in FIG. 1, the user device 10 is a mobile device.

The user device 10 may include functionality for associating a user 2 to a user's loyalty program account including via virtual financial instrument (e.g., charge card, credit card, loyalty card) that is capable of storing, generating, and/or transmitting data and/or application programs. The user device 10 may include a GUID issued to the user by the system 100 to facilitate both online and offline transactions. Although an exemplary embodiment of this invention contemplates electronic identification of a user, e.g., via GUID, other readable and/or read/write data storage and retrieval means are possible, e.g., optical scanner, bar code, RFID, QR code, bar and QR code reader and the like. As such, it may be desirable for some embodiments to utilize a bar code and bar code reader or other similar, yet alternative means of storing and reading data.

An exemplary loyalty application may be configured as a downloadable and executable instruction set, e.g., computer program. The loyalty application contemplates any application implementing the loyalty program functionality described herein. The loyalty application is able to support a single and/or a multi-tier environment and should preferably be able to coexist with other applications that may be stored on the user device. An exemplary loyalty application has the ability for the loyalty program to be set and maintained. The loyalty application is configured to point to an offerer's loyalty program, where the user's identification is keyed to the particular offerer loyalty program.

An exemplary loyalty program embodiment includes an allocation of “points” based on a variety of user actions, such as participation in a computer-implemented game, visits to a participating retailer, purchase of products or services at one or more retailers, entering losing lottery tickets, purchase of qualifying dollar amounts, occurrence of predetermined events including game-based events, and/or satisfaction of grouped criteria, i.e., particular combinations of desired consumer behaviors.

In an exemplary embodiment, user transaction data is transmitted to the system 100 by the user 2 and securely stored. As discussed later, this data is then transmitted to a server 15 for processing, accounting, and billing.

In one embodiment, loyalty program information may be stored by the system 100 for access by the admin-user 5. In this embodiment, the system 100 associates loyalty program information for individual users 2 by any number of identification means (e.g., GUID, transaction card number, social security number, user ID, email address, passcode, etc.). At the time of the transaction with a particular user, the user 2 provides the admin-user 5 or server 15 with identification or authentication information, and the admin-user 5 communicates with the server 15 to access loyalty programs associated with the user 2. The admin-user 5 or server 15 is then able to compare the loyalty point information with the products purchased and process accordingly.

The admin-user 5 may be associated with any product or service provider capable of facilitating the loyalty program functionality herein described. As such, the admin-user 5 may interface with the system using any hardware or software system capable of receiving, via an actual or virtual storefront, user loyalty program data. An exemplary admin-user may interface using a computing device 12.

The system 100 is suitably configured to manage the loyalty program distribution and odds-based computer-implemented games. In an exemplary embodiment shown in FIG. 1, the system 100 comprises, inter alia, a loyalty application server 15, a customer interface system 25 and a loyalty program management module 35. The server 15, system 25, and module 35 may reside on independent computing devices or be implemented in a single computing device, e.g., server 45. In one embodiment, the server 45 includes a network interface device to communicate with the user's device 10 via the network 20 and the admin-user's device 12.

The customer interface system 25 generally facilitates communication between the system 100 and the user and the admin-user 5. The loyalty program management module 35 generally stores, formats and processes the loyalty programs. A loyalty application server 15 may be configured to facilitate settlement of loyalty program coupons and payment between a redeeming retailers 100 (e.g., merchants) and users, including the invoicing and payment of distribution and redemption fees.

The customer interface system 25 may be additionally configured for data processing and virtual storefront or web-based interface. The virtual storefront may have loyalty program-specific functionality or be included in a point-of-sale (POS) or ecommerce module capable of receiving loyalty program data. The system 25 may be configured to receive the user's identification and/or communicate with the module 35 to retrieve loyalty data and may also be configured to transmit to the user's device 10 to reflect recent purchases and accumulation of loyalty points. Additionally, the customer interface system 25 may also be configured to capture purchase data, including product price, product sku (i.e., product name), date of purchase or redemption, retailer identifier (SE#) and/or the like.

In one embodiment, the loyalty program management module 35 may be configured to process product and transaction information, such as retrieval of product information from a product database and comparison with loyalty program information captured from the user's device 10. As one skilled in the art will appreciate, this system may interface with the computing server 45 or may be combined within one retailer system. In an exemplary embodiment, the computing server 45 captures the loyalty information and passes it to the retailer data processing system to compare with product information. The loyalty program management module 35 is configured to communicate with the server 15 to facilitate the settlement and redemption of the loyalty program rewards.

The system 100 includes any method, device or means for distributing the loyalty programs to users 2 or retailers. An exemplary distribution system 100 comprises a customer interface system 25 that facilitates communication between the loyalty program management module 35 and the user. As shown, the customer interface system 25 may also be communicatively connected to the loyalty application server 15 to facilitate communication between the application server 15 and the user. The customer interface system 25 may include any server system connected to any type of distributed network 20, such as the internet. A web server is an example of a customer interface system 25, through which the user and admin-user 5 may communicate with the various loyalty systems to perform any number of tasks, such as to view loyalty accounts, modify loyalty accounts, download loyalty applications, generate reports, and/or the like.

The loyalty program management module 35 is configured in an exemplary embodiment to allow the retailers to create new offers, view offers, generate reports on offers, modify offers, etc. As such, the management module 35 may be suitably connected to the loyalty application server 15 to retrieve loyalty program data, such as how many loyalty program registrations have been made, what type of programs are popular, how many coupons have been redeemed, how many coupons have been issued, and various consumer and retail-based usage metrics etc.

The loyalty application server 15 is configured in an exemplary embodiment as the hub for processing loyalty program data. As such, the loyalty server 15 will contain all data about the loyalty offers and offer terms. The loyalty server 15 will also receive and store all loyalty related transactions (e.g., setup, punch, redemption, etc.). Upon processing each transaction, the loyalty server 15 will calculate any applicable fee for that transaction which will be stored within the loyalty server 15 database and linked to the corresponding transaction.

In one embodiment, user loyalty information is stored within the system and associated with the user by some identification indicia (e.g., charge card number, social security number, passcode, etc.). This identification means may be established via any type of identifying or authenticating means, including, for example, biometric identification (e.g., voice, fingerprint, retinal, etc.). The admin-user 5, at the point of transaction communicates user authentication or identification information to the system 100 to access applicable loyalty program information, to update the associated loyalty program information stored on the system 100 based upon a user's action, e.g. product or service purchase, event occurrence, or rewards redemption. The loyalty program data is managed, as previously described, to provide reporting, tracking, and other desired data management functions.

In one exemplary operation, the user 2 purchases items or orders services via the system 25. When the user proceeds to the checkout, loyalty information corresponding to the user is accessed and updated based upon the transaction by interacting with the loyalty program management module 35 if necessary, and determining if the transaction qualifies the user for a loyalty awards or points. If predetermined criterion is met by the transaction, the computing server 45 updates the user's loyalty awards and points to reflect the transaction. This process may occur many times until a predetermined threshold is achieved whereby the user may be eligible for awards or prizes. Upon qualifying for awards, the user may be selectively presented with an opportunity to redeem the loyalty points for the awards and prizes. If the user desires to redeem the loyalty points, the system updates the user's loyalty points and executes the redemption process. In an exemplary embodiment, the computing server 45 is configured to communicate with a loyalty program management module 35, which captures loyalty awards data, transaction data (e.g., cost, product sku, etc.). The loyalty program management module 35 communicates with the loyalty server 15 to update system loyalty program database files, thus ensuring that the loyalty program is preferably up-to-date after every transaction. In one embodiment, the system 100 maintains user loyalty program data that may be accessed by the user, and/or the admin-user 5 to track, report, modify program data as desired.

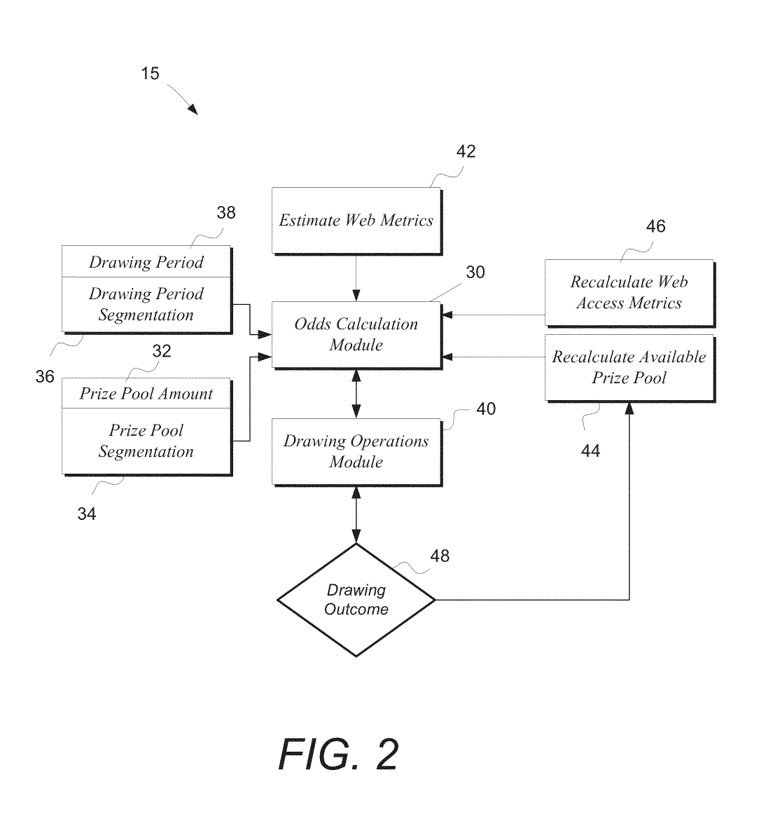

FIG. 2 shows an exemplary embodiment of the server 15 having an odds calculation module 30 and a drawing operations module 40. In various embodiments of the loyalty management system 100, customer drawings, sweepstakes, lottery-based games, and other games having odds as at least one variable in outcome or events within the game are included. Execution of these games may be facilitated by processes within the loyalty application server 15 interfacing with the customer interface system 25.

The odds calculation module 30 is configured to determine odds for a game based upon a preset and/or selectable budget, e.g., a prize pool amount 32, prize pool segments 34, a drawing period 38, drawing segments 36, and lottery-event information 42. Lottery information can include various historical lottery-event data such as ticket sales and jackpots, estimated ticket sales for an upcoming lottery-event, and/or an estimated jackpot for the upcoming lottery-event. Various embodiments may additionally or supplementally determine odds based upon various game attributes, customer usage metrics, and prize values. In one embodiment, odds are selectable by an admin-user 5. In one embodiment, odds for a game are predetermined. Customer usage metrics can include any number of website page view statistics, website traffic metrics, and website time engagement metrics. In one embodiment, customer usage metrics can include statistics related to the particular user, e.g., time spent engaging a particular game or social networking shares of the game and/or web pages. Game metrics can include engagement time, winning or losing streak, quantity of game plays. In one embodiment, the odds calculation module 30 is configured to determine odds for a game based upon extrapolated game play participation from historical participation rates of website traffic. For example, it may be known that 20% of website visitors will engage an offered game upon visiting the website. The odds may then be calculated based upon the budget and an estimated number of winners.

The drawing operations module 40 is configured to transmit and receive information associated with prizes and game and drawing entry information. In one embodiment, the drawing operations module 40 interfaces with the customer interface system 25. In operation, the drawing operations module 40 conducts an odds-based game, the game having a determinable outcome. For example, in an alphanumeric matching game, e.g., numbers matching game, a user selects or is assigned random numbers. The module 40 randomly selects numbers for a predetermined number of draws. A user matching a predetermined number of the drawn numbers with the assigned numbers may be determined to be a winner. Subsequent to determining a game outcome 48, the odds calculation module may recalculate odds based upon recalculated metrics 46 and recalculated funds in the prize pool 44. Recalculated metrics can include recalculated estimated ticket sales for an upcoming lottery-event and/or recalculated estimated jackpots for the upcoming lottery-event.

In one exemplary process, an admin-user provides various game operating parameters including a total value of the prize pool, one or more prize pool segmentation levels, a preset assignment of game types, e.g., instant win and timed drawing games, a drawing period and a drawing segmentation period into the odds calculation module 30. Game types may include instant win drawings or sweepstakes, in which the user is presented with the opportunity to win a prize instantly, or a timed drawing, with the drawing occurring at a specified time. In one embodiment, game types do not include an element of skill to win.

In an exemplary operation, an admin-user may enter $8 million for the total value of the prize pool. The drawing period may be set to a month, with segments being one week. Further to an exemplary settings, a first prize pool segmentation level may be specified as 50% of the prize pool and may be associated with prizes having a first predetermined cash value, e.g., $20 cash value, a second prize pool segmentation level may be specified as having 40% of the total prize pool and may be associated with a second predetermined cash value, e.g., a $30 cash value, and a third prize pool segmentation level may be specified as 10% of the prize pool and may be associated with a third predetermined prize, e.g., prizes having a $100 cash value.

The admin-user can also associate specific prizes with each prize pool segmentation level. For example, the admin-user may specify that the first prize pool segmentation level is associated with a $20 gift card, and/or the third prize pool segmentation level is associated with a tablet computer. The operator can also associate the sweepstakes events or drawings with a range of prizes at a particular price point through an online store, for example allowing a drawing winner to select $20 gift cards from a range of retailers. In one embodiment, the drawings operation module 40 exports the calculated odds to a stand-alone prize display and a drawing entry module.

In one embodiment, the odds calculation module 30 utilizes anticipated page views for identified web pages to determine odds for various games. In operation, an admin-user may identify web pages and provide a quantity of the anticipated page views. In one embodiment, the odds calculation module 30 includes functionality to estimate web pages based upon predetermined criteria. For example, web page view may be determined based upon a current lottery winning pool amount, e.g., $100 million. In operation, an admin-user may provide the current lottery winning pool amount for the odds calculation module 30 to then estimate a likely number of page views for a predetermined time period, e.g., the drawing period, based upon historical page view information of like-sized lottery winning pools or extrapolated based upon preceding lottery events. The odds calculator module 30 processes this information to project the drawing odds necessary to distribute the correct number of prizes for each prize pool segmentation. As described herein above, the odds calculation module 30 then provides the determined odds to the drawing operations module 40.

The drawing operations module 40 is configured to create lottery or sweepstakes-based events, e.g., drawings, for each of the specified prize segmentations. The drawing operations module 40 may be configured to assign different calculated odds to each prize pool. The drawings or sweepstakes events may be displayed to a player-user via the customer interface system 25.

After providing settings for the various sweepstakes or games, and determining odds for various aspects of the games, the drawing operations module 40 then executes the drawings or sweepstakes events for the drawing period. In one embodiment, the sweepstakes events may include instant win and timed drawings.

The lottery rewards program may include various participation criteria and membership-based parameters for drawing entry. For example, rewards members, i.e., users, may be provided a predetermined quantity of drawing entries or participation in a predetermined quantity of sweepstakes events to use among the total possible drawings or events. In one embodiment, the users are assigned drawing entries based upon the user's purchase of lottery tickets. In operation, the drawing operations module 40 executes the instant win and timed drawings and provides notifications of outcomes of the different drawings to the user and the system.

At the conclusion of a drawing segmentation period, e.g., one week, or upon occurrence of an event, e.g., available funds reach a predetermined threshold, the drawing operations module 40 reports to the odds calculation module 30 the number and total value of prizes won. The admin-user may update the current winning lottery pool value. The odds calculation module 30 may then recalculate odds of games and sweepstakes events associated with the remaining prize pool over the remainder of the drawing period. These odds are exported back to the drawing operations module 40 and used to create drawings or sweepstakes events for the upcoming increment. In one embodiment, odds are recalculated for each drawing segmentation period of the drawing period upon expiration of a preceding drawing segmentation period.

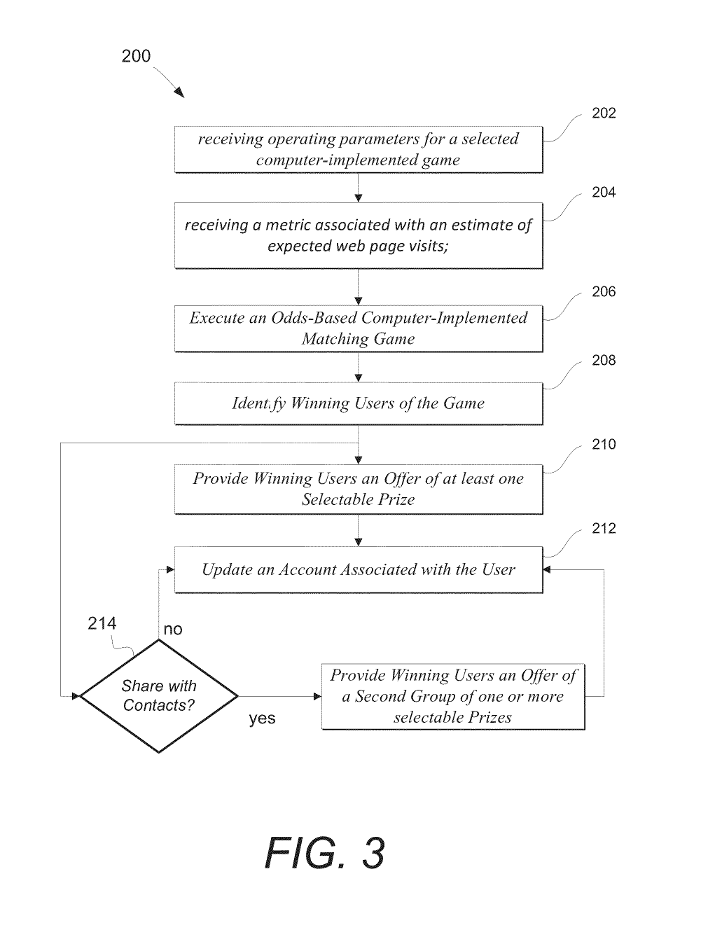

FIG. 3 shows a process 200 for awarding prizes corresponding to winning games and/or sweepstakes events. As FIG. 3 shows, the process includes receiving operating parameters for a selected computer-implemented game 202. At step 204, the system estimates or receives an estimated metric associated with an estimate of expected web page visits for an identified web page or set of web pages. At step 206, a selected game or sweepstakes 202 is executed within the system 100. In one embodiment, the executing may occur in the mobile device 10 or within the customer interface system 25. The executing may be executed based upon the odds determined as described herein above for a selected game, e.g., instant win drawing or a timed drawing game.

At step 208, the system identifies one or more user as winners of the game. The winners may be then presented with one or more prizes corresponding to a prize pool segmentation level 210. In various embodiments, certain game attributes may be associated with segments of the prize pool segmentation levels. In the exemplary embodiment of a matching game, for example, a user matching four alphanumeric characters may be identified as a winner of a first segmentation level, a user matching five alphanumeric characters may be identified as a winner of a second segmentation level, etc. The segmentation level may also be associated with a particular event within the game associated with a user's play or based upon a time period within the drawing period. In a particular embodiment, a user matching a predetermined number of a total quantity of alphanumeric characters may win a first segmentation level pool prize, e.g., $20, while a user matching all of the alphanumeric characters may win a second level pool prize, e.g., $100. The system is configured to receive a user's prize selection and update a loyalty program account associated with the user based upon the selection and/or game play of the user 212.

In one embodiment, upon winning, a user is concurrently provided with a first group of one or more prizes from which to select and an option to change the winning prizes to a second group of one or more prizes if the user shares or distributes notice of the user's win to a third-party group, e.g., social networking users 214. If the user distributes notice of the win, or of the game, via a social networking system then user is presented with a second group of one or more prizes from which to select 216. In one embodiment, the second group of prizes is expanded from the first group. In one embodiment, the second group of prizes includes prizes associated with a greater pecuniary value than the first group. In one embodiment, upon winning the user may be presented with the first group of prizes to select from and concurrently presented with the second group along with the option to distribute notice of the user's win or gameplay via a social networking system, i.e., selection of any particular prize associated with the second group being contingent upon the user sharing their contest/drawing victory with their social networks contact or “friends.”

In one embodiment, a loyalty program admin-user is able to specify a range of different expanded prize pool options, for instance within a category of prizes (gift cards that could be redeemed for electronics or housewares, or by category of prizes (prizes that appeal to a predetermined demographic group). Further, loyalty program operators can use the prize presentation engine to allow the users themselves to select the possible categories of expanded prizes. This user selection further increases the perceived benefit to the user and allows the loyalty program operator to collect additional information on the user's preferences. In one embodiment, the expansion of possible prizes may be based upon a number of different social networks through which the user shares and/or a quantity of social networking contacts associated with the user.

The loyalty program may include providing the user with points or loyalty currency for a range of actions and activities. Actions can include awards for purchases, both online and in physical locations, cumulated purchase spending, activities within the loyalty program and recommending the loyalty program to friends and family. The loyalty program user is presented with opportunities to enter into drawings or contests. The option of entering could be presented to all or sub-sets of the loyalty program participants, and could require the “expenditure” or redemption/conversion of points or loyalty currency in exchange for an entry or entries.

Website and web page traffic related to a lottery-based websites varies according to the size of the prize pool. As the size of the lottery prize pool grows, the traffic to the website grows as well, and not always in a linear fashion. Because of the aspect of chance, lotteries have a difficult time forecasting the traffic to their website in upcoming months and thus to their loyalty program websites. This random variance in website traffic can complicate the process of operating a loyalty program and the odds for any drawings or contests. If the odds are set too high, in anticipation of a growing lottery prize pool, and then someone wins, the loyalty program will give out too few prizes and will not meet the amount promoted in its marketing campaign. Giving away fewer prizes than promised has a chance to undermine the credibility of the rewards program and cause lottery players to avoid it. Conversely, if the odds are set too low and traffic to the website spikes with the size of the lottery wining pool, the rewards program could give away far more prizes than projected, causing the program to exceed its budget. Therefore, lottery rewards programs would benefit from generating odds dynamically in response to the variable traffic to the rewards program website.

Example functions of a social networking system can include:

Personal User Profiles—Members of a community may be provided a personalized page with which they can provide profile information, their photo, a personal description, their interests, among other information about the user. Each member may also be provided a personal portfolio where they may upload images, documents, videos, or any other type of information. Such information may be selectively shared with the community, such as on a user-by-user basis, group basis, or by any other type of parameters. To this end, controls may be provided to the user to modify and create such access. In one embodiment, a personal user profile may be integrated with a user's loyalty program account. For example, loyalty program may be displayed along with loyalty rewards and/or loyalty points information.

In various embodiments of the social networking system, the user may be located by other users based on the information provided in their personal page. This information may be accessed by users such as contacts of the user. The personal user profile may include status information relating to the user, such as, for example, current location, ranking, various associated game attributes, etc. Such information may be generated, for example, by a server as discussed above. Such server-based content may be generated as needed and displayed in the personal user profile of the user, or in other types of interfaces generated by the system (e.g., a top user's screen, a location map, etc.).

Further, in another example, users may have “friends” i.e., contacts, or other associations with other users that are stored by the system. This association information may be displayed by a user to other users on their personal page, or in other interface types generated by the system. Another function that may be performed by the system includes a referral network where users may locate other users through their associations with other users. To this end, tools may be provided that permits users to refer other users or otherwise contact users in their individual networks.

The social networking system may include a newsfeed or other information display module configured to share user-generated content including linked internet content, e.g., hyperlinks. The newsfeed may be configured, in various embodiments, to allow users to create, collaborate, and share knowledge to which each user may contribute. For example, a user may be permitted to create their own weblog where other permitted members (e.g., a group of friends or other permitted users) may share information with the user and the group as a whole.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. A method for providing rewards to a loyalty program customer, the method comprising:
receiving operating parameters for a selected computer-implemented game, the operating parameters including a total value of a prize pool, one or more prize pool segmentation levels, a drawing period and one or more drawing segmentation periods;
receiving lottery-based information associated with a lottery-event, wherein the lottery-event is not controlled by the selected computer-implemented game;
determining odds for the selected computer-implemented game based upon the received operating parameters and the lottery-based information;
executing the selected computer-implemented game based upon the determined odds and the received operating parameters;
determining a reward for the loyalty program customer based at least in part on the executing of the selected computer-implemented game;
providing an offer of the reward to the loyalty program customer; and
updating an account associated with the loyalty program customer based upon the providing.

2. The method of claim 1, wherein the lottery-based information includes a metric associated with an estimate of web page visits and wherein the odds are further determined based upon the estimated expected quantity of web page visits.

3. The method of claim 1, wherein the lottery-based information includes a metric associated with estimated ticket sales associated with the lottery-event and wherein the odds are further determined based upon the metric associated with estimated ticket sales associated with the lottery-event.

4. The method of claim 1, wherein the lottery-based information includes an estimated jackpot associated with the lottery-event and wherein the odds are further determined based upon the estimated jackpot associated with the lottery-event.

5. The method of claim 1, wherein the lottery-based information includes at least one of a metric associated with an estimate of web page visits, a metric associated with estimated ticket sales associated with the lottery-event, historical ticket sales, and an estimated jackpot associated with the lottery-event.

6. The method of claim 1, wherein the computer-implemented game is selected from one of an instant win and a timed drawing game type, wherein the game types include matching a user's assigned alphanumeric characters to drawn alphanumeric characters.

7. The method of claim 1, further comprising:
recalculating odds for a subsequent drawing segmentation period upon expiration of a preceding drawing segmentation period.

8. The method of claim 1, wherein the one or more prize pool segmentation levels are each associated with a reward.

9. The method of claim 1, further comprising:
providing an option to change the offer of the reward based upon sharing of the computer-implemented game with contacts of the loyalty program customer within a social networking system.

10. The method of claim 1, further comprising:
providing an option to change the offer of the reward based upon distribution of information associated with the loyalty program customer's use of the selected computer-implemented game.

11. The method of claim 1, further comprising:
providing an option to distribute information associated with the selected computer-implemented game to social networking contacts of the loyalty program customer;
distributing the information based upon actuation of the option; and
further determining the reward for the loyalty program customer based upon the distributing.

12. A method for providing rewards to a loyalty program customer, the method comprising:
receiving operating parameters for an odds-based computer-implemented matching game, the operating parameters including a total value of a prize pool, one or more prize pool segmentation levels, a drawing period and one or more drawing segmentation periods;
extrapolating ticket sales for a lottery-event based upon historical ticket sales and associated historical jackpots;
determining odds based upon the received operating parameters and the extrapolated ticket sales;
executing the odds-based computer-implemented matching game based upon the determined odds and the received operating parameters;
determining a reward for the loyalty program customer based at least in part on the executing of the odds-based computer-implemented matching game;
providing an offer of the reward to the loyalty program customer; and
updating an account associated with the loyalty program customer based upon the providing.

13. The method of claim 12, wherein the odds-based computer-implemented matching game is one of an instant win and a timed drawing game type.

14. The method of claim 12, further comprising:
recalculating odds for a subsequent drawing segmentation period upon expiration of a preceding drawing segmentation period.

15. The method of claim 12, wherein the one or more prize pool segmentation levels are each associated with a reward.

16. The method of claim 15, further comprising:
providing an option to change the offer of the reward based upon sharing of the odds-based computer-implemented matching game with contacts of the loyalty program customer within a social networking system.

17. The method of claim 15, further comprising:
providing an option to change the offer of the reward based upon distribution of information associated with the loyalty program customer's use of the odds-based computer-implemented matching game.

18. The method of claim 12, further comprising:
providing an option to distribute information associated with the odds-based computer-implemented matching game to social networking contacts of the loyalty program customer;
distributing the information based upon actuation of the option; and
further determining the reward for the loyalty program customer based upon the distributing.

19. A method for providing rewards to a loyalty program customer, the method comprising:
receiving operating parameters for an odds-based computer-implemented matching game, the operating parameters including a total value of a prize pool, one or more prize pool segmentation levels, a drawing period and one or more drawing segmentation periods;
receiving lottery-based information associated with a lottery-event, wherein the lottery-event is not controlled by the selected computer-implemented game, wherein the lottery-based information includes a metric associated with an estimate of web page visits, a metric associated with estimated ticket sales associated with the lottery-event, historical ticket sales data, and an estimated jackpot associated with the lottery-event;
determining odds based upon the received operating parameters and the lottery-based information;
executing the odds-based computer-implemented matching game based upon the determined odds and the received operating parameters;
determining a reward for the loyalty program customer based at least in part on the executing of the selected computer-implemented game;
concurrently providing an offer of the reward to the loyalty program customer and an option to change the reward based upon distribution of information associated with the odds-based computer-implemented matching game to social networking contacts of a loyalty program customer; and
updating an account associated with the loyalty program customer based upon the providing.

20. The method of claim 19, wherein the distribution of information associated with the odds-based computer-implemented matching game to social networking contacts of a loyalty program customer includes web-based posts.

21. The method of claim 19, wherein the distribution of information associated with the odds-based computer-implemented matching game to social networking contacts of a loyalty program customer includes subscription feeds.

22. The method of claim 19, wherein the method is executable by at least one processor of a computer system having a non-transitory computer-readable medium comprising a set of instructions that, when executed, cause the computer system to perform the method.

23. The method of claim 19, wherein the odds are further determined based upon a correlatable metric of an expected jackpot associated with a lottery.
